(19) United States
(12) Patent Application Publication
(10) Pub. No.: US 2018/0107720 A1
(43) Pub. Date: Apr. 19, 2018

(54) DYNAMIC ASSIGNMENT OF SEARCH PARAMETERS TO SEARCH PHRASES

(71) Applicant: Target Brands, Inc., Minneapolis, MN (US)

(72) Inventors: Christopher Edward Johnson, Plymouth, MN (US); Dakota Reese Brown, St. Paul, MN (US); Russell Roy Sanborn, St. Paul, MN (US); Joseph Andrew Downing, Minneapolis, MN (US)

(21) Appl. No.: 15/293,977

(22) Filed: Oct. 14, 2016

(51) Int. Cl. G06F 17/30

(52) U.S. Cl. CPC G06F 17/30554; G06F 17/30424

(57) ABSTRACT

A computer-implemented method receives a search phrase from a client device and identifies a category of products that was previously assigned to the search phrase, wherein the category of products was previously assigned to the search phrase based on products selected by previous users who entered the search phrase. Search parameters associated with the category are retrieved and are used to control the content of a search result page that is formed in response to the received search phrase. The search result page is then returned to the client device.

### BACKGROUND

On retail websites, users are able to enter search phrases to search for particular products. The webservers then compare these search phrases to various product attributes to identify a collection of products to be returned for the search phrase. The products are displayed in a search results page based on a set of search result parameters. These search result parameters define such things as the number of products to show, the size of the images of the products to show, and product filters, commonly referred to as facets, that are to be displayed to allow the user to further filter the search results, by for example, limiting the search results to particular colors or particular sizes of items.

Some facets are only relevant to particular classes of products. For example, a megapixel facet, which allows a user to designate a range of megapixels, is only applicable to electronic devices that have cameras. Displaying a megapixel facet with other products, such as clothing, wastes valuable screen space making it more difficult for the user to find the products they want.

The number of possible search terms is virtually unlimited. This makes it difficult to assign all search phrases to a particular set of search result parameters. Even if a limited number of search phrases were assigned to particular search result parameters, this assignment can become quickly outdated as new products are introduced. For example, if a search phrase had previously been used only as an adjective for a particular class of products, it could have its search results set for that class of products. However, if a new product came on the market that used that adjective as its name, and the new product was not in the same class of products, the search result parameter set for the search phrase would no longer be appropriate. Given the large number of new products that are introduced every year, keeping track of all of these occurrences by hand is extremely difficult and time consuming.

The discussion above is merely provided for general background information and is not intended to be used as an aid in determining the scope of the claimed subject matter. The claimed subject matter is not limited to implementations that solve any or all disadvantages noted in the background.

### SUMMARY

A computer-implemented method receives a search phrase from a client device and identifies a category of products that was previously assigned to the search phrase, wherein the category of products was previously assigned to the search phrase based on products selected by previous users who entered the search phrase. Search parameters associated with the category are retrieved and are used to control the content of a search result page that is formed in response to the received search phrase. The search result page is then returned to the client device.

In a further embodiment, a server includes a memory and a processor. The memory stores search parameters for each of a plurality of categories. The processor executes instructions to perform steps including identifying a list of products selected by users after the users entered a search phrase, identifying a category that products in the list of products belong to, and assigning the category to the search phrase. The search phrase is then received and the processor retrieves the search parameters for the category assigned to the search phrase and uses the retrieved search parameters to return search results.

In a still further embodiment, a method includes at set intervals: identifying products selected from search results returned for a search phrase during a latest interval; identifying a category of products from the identified products; and assigning the category to the search phrase. The search phrase is then received in a search request and the category assigned to the search phrase is retrieved. Search parameters assigned to the category are then retrieved and used to return search results based on the received search phrase.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a flow diagram of a method of collecting search phrase data.

FIG. 2 is a block diagram of a system used in accordance with the various embodiments.

FIG. 3 is a user interface of search results using default search result parameters.

FIG. 4 is a flow diagram of a method of assigning category search result parameters to search phrases.

FIG. 5 provides a flow diagram for identifying search result parameters to use for a search phrase.

FIG. 6 is a user interface showing search results after the search phrase of FIG. 3 has been assigned to a category.

FIG. 7 is a block diagram of a computing system used in various embodiments.

### DETAILED DESCRIPTION

In the embodiments described below, methods and systems are provided for improving a computing system's ability to identify how searches are to be performed and how search results are to be returned for particular search phrases. In particular, the methods and systems keep track of which products are selected from search result pages for each search phrase entered by users over a time interval, such as a week, for example. Each time a product is selected over the interval, a category assigned to the product has its count incremented for the search phrase. For each search phrase, the category counts are examined to determine if one category received a majority of the product selections for the search phrase. If there is such a category, search rules and search parameters that have been assigned to this category are then assigned to the search phrase and are used to perform the search and to provide the search results for the search phrase. As a result, the facets that are displayed, the size of the images displayed and the number of products displayed in the search results for a search phrase are automatically set to the values set for the category assigned to the search phrase. The assignment of the search phrases to the categories is repeated on a periodic basis, such as weekly, so that as consumers change their product selections, the categories assigned to the search phrases can change dynamically and automatically so that the search results are provided in a manner that is most helpful to consumers.

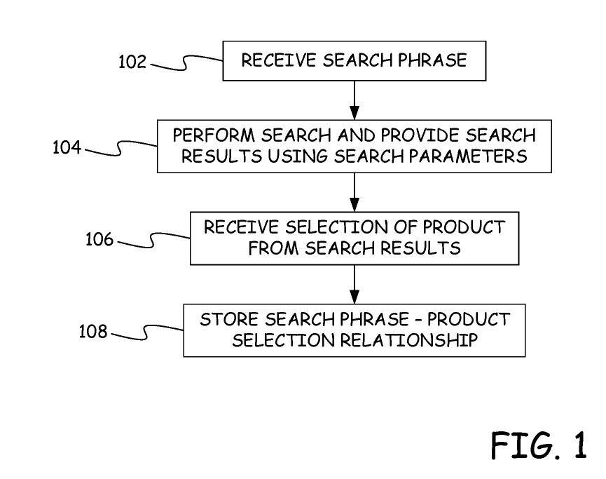

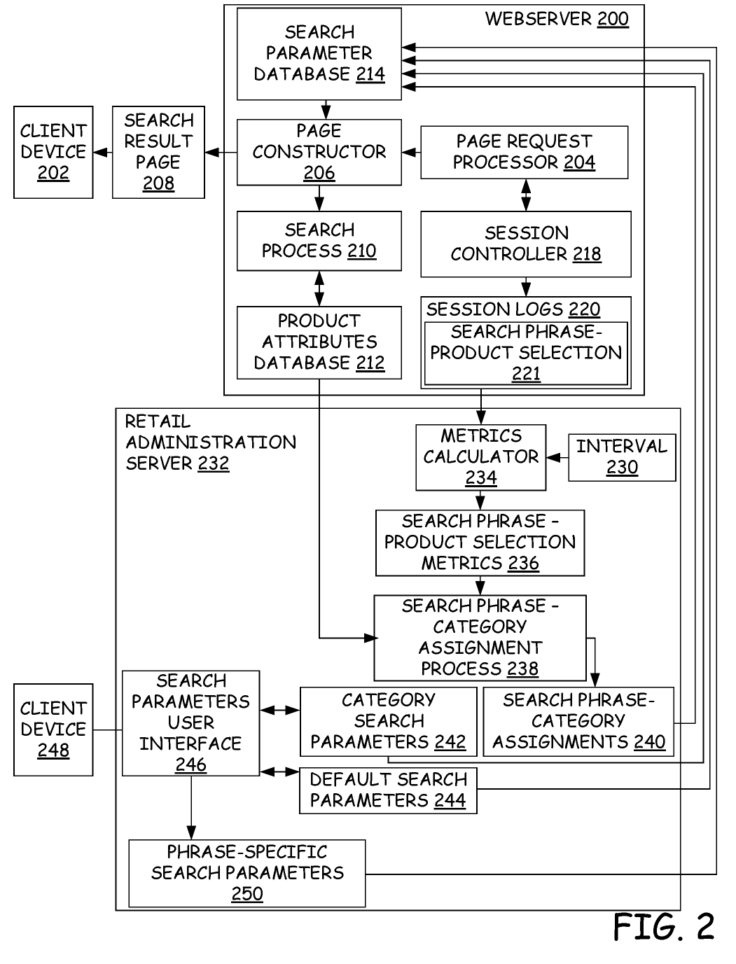

FIG. 1 provides a flow diagram of a method of collecting product counts for search phrases over an interval using the system of FIG. 2. In FIG. 2, a webserver 200 provides webpages to a collection of client devices, which are depicted in FIG. 2 by a single representative client device 202. One or more of those pages include search control boxes that can receive search phrases that are transmitted by client device 202 to webserver 200 and are received by page request processor 204 at step 102 of FIG. 1. Page request processor 204 provides the search phrase and an indication that a search result page is to be generated to a page constructor 206.

At step 104, page constructor 206 performs a search using the search phrase and provides search results using a set of search parameters that include search rules for performing the search and search result parameters for creating the search result page 208. In particular, page constructor 206 passes the search phrase to a search process 210, which searches product attributes database 212 using search rules retrieved from a search parameter database 214. The search rules define which fields of the product attributes database 212 to search, relative weights to apply to each field for ordering the search results based on relevancy, and how terms in the search phrase should be modified before performing the search. Search phrases can be modified in a number of ways including adding or removing stems on search words, adding other versions of search words to the search phrase, adding synonyms for some search words, and replacing certain search words with completely different words, for example.

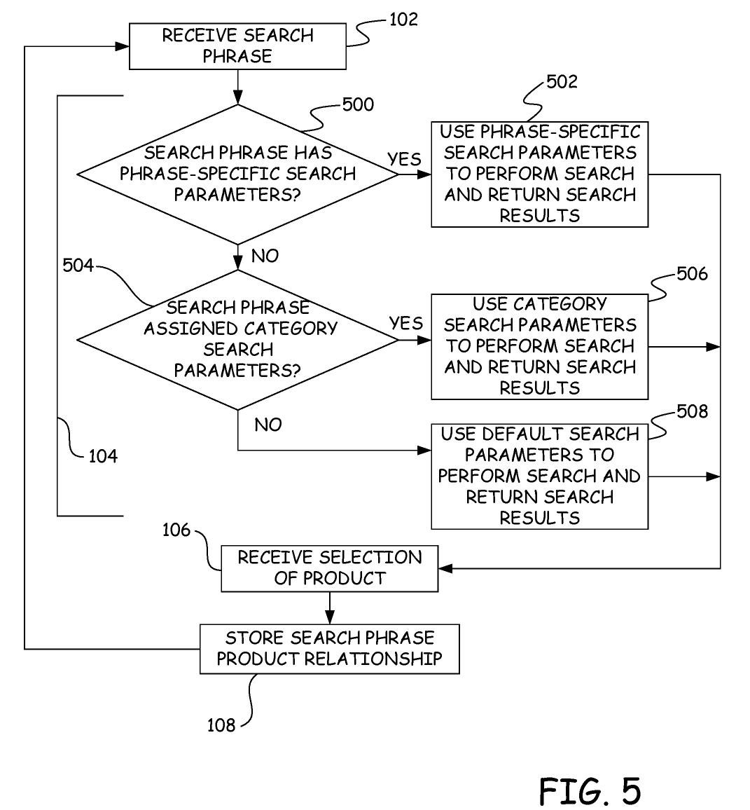

Product attributes database 212 contains multiple fields with words and phrases in each field that describe the product. In addition, product attributes database 212 includes the location of each product in a category hierarchy. For example, the category hierarchy can include an upper level groups category, a middle level divisions category, and a lower level departments category. For example, a groups category of “hard lines” has within it multiple divisions include an “electronics” division, which in turn has multiple departments within it, such as “home electronics”. The selection of the search rules and search parameters used in step 104 is discussed further below in the flow diagram of FIG. 5.

Using client device 202, a user selects a product from search result page 208 and that selection is received by page request processor 204 at step 106. Page request processor 204 provides the selected product and the search phrase to a session controller 218, which stores the link between the search phrase and the selected product in session logs 220 at step 108 as search phrase-product selection 221, which in one embodiment is a list of products selected by users who entered the search phrase.

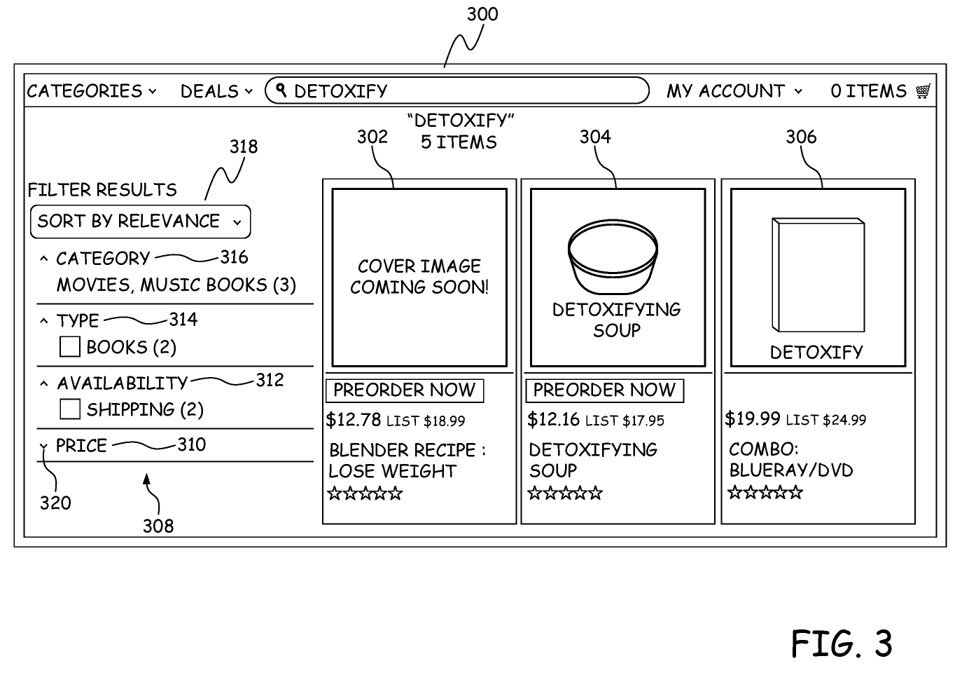

FIG. 3 provides an example of a user interface 300 showing a search results page. The search results page of FIG. 3 is for the search phrase “detoxify” and five items were returned, although only three products 302, 304 and 306 are shown. User interface 300 also includes facets 308 that include a price facet 310, an availability facet 312, a type facet 314, a category facet 316, and a sort by facet 318. Sort by facet 318 is a pulldown control that allows the user to select different ways to sort the search results including by relevancy, low-to-high prices, high-to-low prices, average ratings and newest, for example. Category facet 316 allows the user to filter out all products that are not within a particular category, such as the “Movies, Music and Books” category. Category facet 316 corresponds to categories provided within the hierarchy of categories described above. Type facet 314 allows the user to view only those products that fall within a particular type, such as books. Availability facet 312 allows the user to view only products that have particular availability, such as via shipping or via a retail store. Price facet 310 allows the user to select to view only those products that fall within a particular price range. Of facets, 310, 312, 314 and 316, facets 312, 314 and 316 are said to be open while price facet 310 is said to be closed. In particular, it is possible to make a selection of one of the facet values for facets 312, 314 and 316, but it is not possible to select a value for price facet 310 without first selecting carrot 320 to open price facet 310 and view the available values of price facet 310.

When a user clicks on a product, such as product 306, in user interface 300, client device 202 returns the identifier for the product to page request processor 204 to request a page dedicated to the product. Session controller 218 then stores the identifier for the product together with the search phrase at step 108 as search phrase-product selection 221 while page constructor 206 constructs and returns the page dedicated to the product.

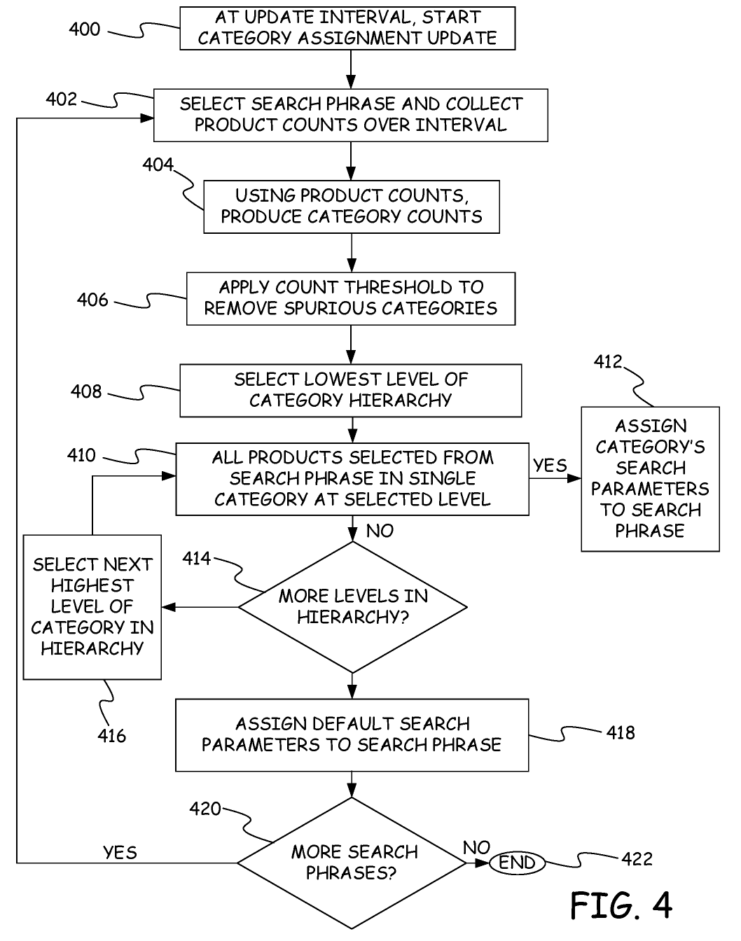

FIG. 4 provides a flow diagram of a method of assigning search parameters to a search phrase using the products selected by users who previously entered the search phrase. As shown in the flow diagram of FIG. 4 and in the system diagram of FIG. 2, at an update interval 230 stored in a retail administration server 232, a metrics calculator 234 starts a category assignment update at step 400. At step 402, metrics calculator 234 accesses session logs 220 and selects a search phrase that was used during interval 230. For the chosen search phrase, metrics calculator 234 collects the product counts for each product selected from a search results page generated for the chosen search phrase during the interval. For example, if five different products were selected from search result pages for a particular search phrase, the counts of the number of times each product was selected are collected at step 402. The results of step 402 are stored as search phrase-product selection metrics 236 in retail administration server 232. In one embodiment search phrase-product selection metrics 236 is a list of products selected by previous users who entered the search phrase during the interval and does not include products selected outside of the interval.

At step 404, a search phrase-category assignment process 238 uses search phrase-product selection metrics 236 and product attributes database 212 to generate category counts for each search phrase. In particular, search phrase-category assignment process 238 retrieves the category hierarchy for each product that was selected by a search phrase. For example, the category hierarchy can include the department, the division, and the group that the product is assigned to. The count for the department category, the division category, and the group category of the product are then each incremented by the count assigned to the product for the search phrase. For example, if a movie was selected five times for the search phrase “detoxify”, and the movie was under the MOVIES department, within the MOVIES AND BOOKS division of the HARD LINES group, the MOVIES department would have its count incremented by five, the MOVIES AND BOOKS division would have its count incremented by five and the HARD LINES group would have its count incremented by five. This is repeated for each product that was selected during the interval for the chosen search phrase resulting in final category counts for the search phrase over the interval.

At step 406, a count threshold is applied to the category counts to remove spurious categories. For instance, if a category was only selected once during the interval, its count would be reduced to zero. At step 408, search phrase-category assignment process 238 selects the lowest level in the category hierarchy. For example, at step 408, search phrase-category assignment process 238 would select the department level in the category hierarchy. At step 410, search phrase-category assignment process 238 determines if there is a single category at the selected level that covers a majority of products selected for the search phrase during the time interval. If there is a single category, the category's search parameters are assigned to the search phrase at step 412. In other embodiments, at step 410, search phrase-category assignment process 238 determines if there is only one category at the selected level that has a non-zero count after applying the count thresholds at step 406. If there is only one category, that category's search parameters are assigned to the search phrase at step 412.

If none of the categories cover a majority of the products that are selected, the process determines if there are more levels in the hierarchy at step 414. If there are more levels in the hierarchy, the process continues at step 416 where the next highest level of categories in the hierarchy is selected and step 410 is repeated for this new level in the hierarchy. For example, after examining the department level at step 408, the process selects the division level at step 416 and after examining the division level, the process selects the group level at step 416.

When there are no more levels in the hierarchy at step 414, default search parameters 244 are assigned to the search phrase at step 418. The assignment of the category search parameters or the default search parameters results in search phrase-category assignments 240 in retail administrative server 232.

As shown above, the steps of FIG. 4 assign a category to a search phrase based on products selected by a number of users of webserver 200. Since this assignment occurs after the users of webserver 200 have selected products, the users are referred to as previous users who entered the search phrase or previous users during an interval who entered the search phrase.

The process of FIG. 4 then determines if there are more search phrases to process for the interval. If there are more search phrases, the next search phrase is selected by returning to step 402 and steps 402-418 are repeated. When there are no more search phrases, the process ends at step 422.

The category search parameters 242 and the default search parameters 244 can be defined through search parameters user interfaces 246 using a client device 248. The search parameters include search rules that govern how a search is performed including product fields in an index of product attributes database 212 to be searched, whether to search for variations on the search phrase, weights to apply to product fields, and whether to use a classifier to identify products to return for the search phrase. The search rules regarding variations of a search phrase can include rules for adding or removing search terms to the search phrase and for modifying words in the search phrase using various stemming rules that add or remove stems, such as “ing”, “es”, and “s”, for example.

The search parameters also include search result parameters that describe how the search results are to be displayed, such as search result parameters used to determine which facets appear on the search result page, search result parameters used to control which facets appear in an expanded form on the search results page, search result parameters used to control sizes of product images in the search results page and search result parameters are used to control sorting of products in the search results page, for example. The search result parameters can also be described as parameters that describe at least one of a facet for filtering search results, a state for a facet, a size for product pictures in the search results, and how to sort products in the search results.

Search rules user interface 246 also allows phrase-specific search parameters 250 to be set, which are search parameters that are only used for a particular search phrase. These phrase-specific search parameters can include search rules used to control how the search is performed and search result parameters that control how the search results are displayed.

The search phrase-category assignments 240, as well as default search parameters 244, category search parameters 242 and phrase-specific search parameters 250 are stored in search parameter database 214 on webserver 200 and are used by page constructor 206 to control the searching performed for search phrases and to control the content and appearance of the search result pages. In particular, search phrase-category assignments 240 and phase-specific search parameters 250 are stored in database 214 such that searches for a search phrase can be made to determine if the search phrase has been assigned to a category and to determine if the search phrase has phrase-specific search parameters.

FIG. 5 provides a flow diagram of a method that uses search parameter database 214 to perform searches and to return search results. FIG. 5 represents an expanded version of the flow diagram of FIG. 1 where the step of performing a search and providing search results shown as step 104 of FIG. 1 has been expanded to show the sub-steps performed during that step.

In FIG. 5, after receiving the search phrase at step 102, page constructor 206 examines search parameter database 214 to determine if the search phrase has a phrase-specific set of search parameters at step 500. If the search phrase has phrase-specific search parameters, search process 210 uses the search rules set in the phrase-specific search parameters to perform the search and page constructor 206 uses the search results parameters of the phrase-specific search parameters to control the appearance and content of search result page 208 at step 502.

If the search phrase does not have a phrase-specific set of search parameters at step 500, page constructor 206 determines if the search phrase has been assigned a category's search parameters at step 504. If the search phrase has been assigned to a category in search phrase- category assignments 240, page constructor 206 retrieves that search parameters for the assigned category at step 506 and uses the search rules of those search parameters to control how the search is performed by search process 210 and the search results parameters of those search parameters to control the appearance and content of search result page 208.

If the search phrase has not been assigned to a category at step 504, page constructor 206 uses the default search parameters at step 508 to control how the search is performed and the appearance and content of the search results in search result page 208. After steps 502, 506 and 508, page request processor 204 receives the selection of a product at step 106 from the products returned in search result page 208. Session controller 218 then stores the selected product and the search phrase as search phrase-product selection 221 in session logs 220 at step 108. The process of FIG. 5 then returns to step 102.

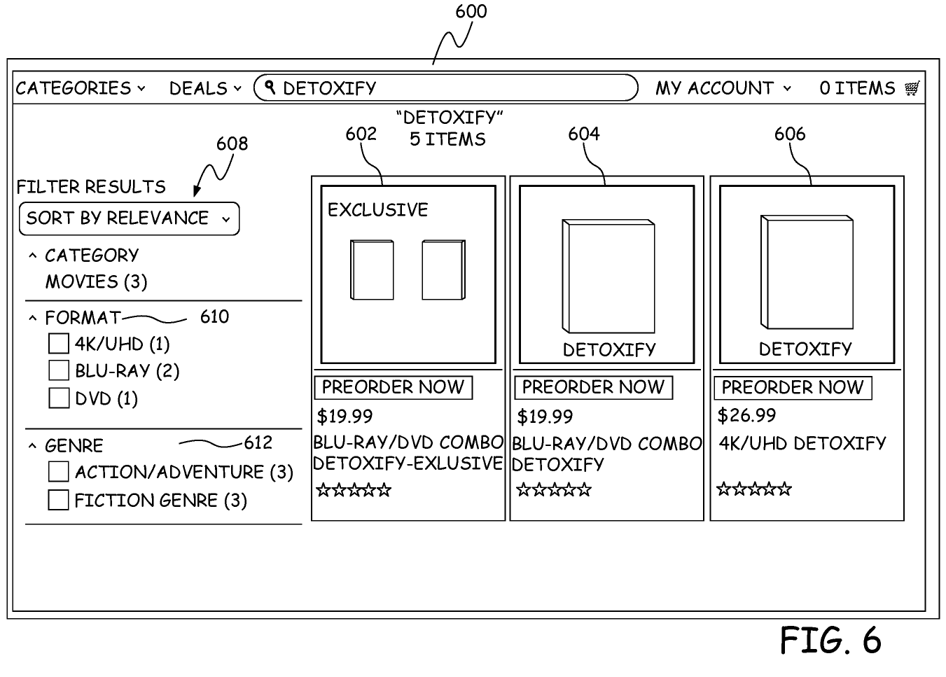

FIG. 6 provides an example user interface 600, which shows how the search results page changes from user interface 300 of FIG. 3 after an interval during which the searchers of the term “detoxify” selected substantially only movies during the interval. Based on these selections, the search phrase “detoxify” was assigned to the movies category resulting in a number of changes in search results user interface 600. In particular, the search results have been reordered, such that products directed to movies are shown at the top of user interface 600 as shown by product entries 602, 604 and 606. In addition, user interface 600 shows that facets 308 have been changed to facets 608 to now include a format facet 610, which is dedicated to movie formats and genre facets 612, which are dedicated to movie genres. Thus, facets 608 are the facets associated with the movie category. The changes in user interface 600 relative to user interface 300 show the improvement to the computing system provided by the present invention. In particular, using only the products selected by users during an interval, the computing system is able to dynamically adapt and provide facets 608 and return products that are more likely to be relevant to a user's search term “detoxify”. This automatic assignment of the MOVIES category's search parameters does not require a person to recognize what consumers are actually searching for and as a result, the computing system reacts faster than it would if a person had to monitor all of the thousands of search terms submitted during the interval.

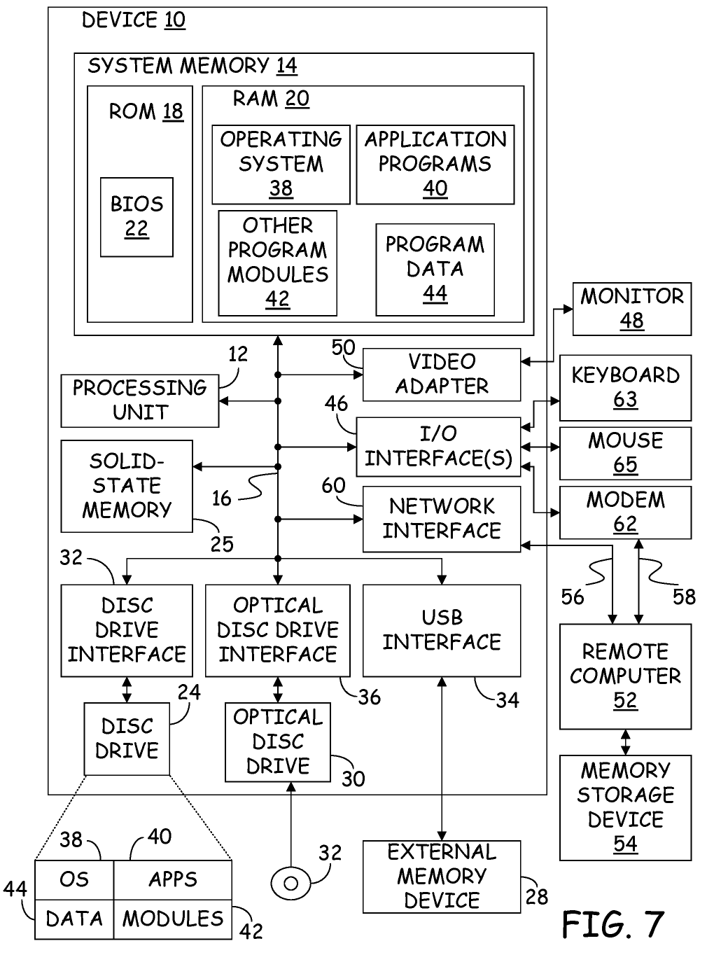

FIG. 7 provides an example of a computing device 10 that can be used as a server device or client device in the embodiments above. Computing device 10 includes a processing unit 12, a system memory 14 and a system bus 16 that couples the system memory 14 to the processing unit 12. System memory 14 includes read only memory (ROM) 18 and random access memory (RAM) 20. A basic input/output system 22 (BIOS), containing the basic routines that help to transfer information between elements within the computing device 10, is stored in ROM 18. Computer-executable instructions that are to be executed by processing unit 12 may be stored in random access memory 20 before being executed.

Embodiments of the present invention can be applied in the context of computer systems other than computing device 10. Other appropriate computer systems include handheld devices, multi-processor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present invention may be accomplished utilizing either local or remote storage devices, or simultaneously utilizing both local and remote storage devices.

Computing device 10 further includes an optional hard disc drive 24, an optional external memory device 28, and an optional optical disc drive 30. External memory device 28 can include an external disc drive or solid state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives and external memory devices and their associated computer-readable media provide nonvolatile storage media for the computing device 10 on which computer-executable instructions and computer-readable data structures may be stored. Other types of media that are readable by a computer may also be used in the exemplary operation environment.

A number of program modules may be stored in the drives and RAM 20, including an operating system 38, one or more application programs 40, other program modules 42 and program data 44. In particular, application programs 40 can include programs for implementing any one of page request processor 204, session controller 218, page constructor 206, search process 210, metrics calculator 234, search phrase-category assignment process 238, and search parameters user interface 246, for example. Program data 44 may include data such as data in session logs 220, product attributes database 212, search parameter database 214, interval 230, search phrase-product selection metrics 236, default search parameters 244, category search parameters 242, phrase-specific search parameters 250, and search phrase-category assignments 240, for example.

Processing unit 12, also referred to as a processor, executes programs in system memory 14 and solid state memory 25 to perform the methods described above.

Input devices including a keyboard 63 and a mouse 65 are optionally connected to system bus 16 through an Input/Output interface 46 that is coupled to system bus 16. Monitor or display 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

The computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 7. The network connections depicted in FIG. 7 include a local area network (LAN) 56 and a wide area network (WAN) 58. Such network environments are commonplace in the art.

The computing device 10 is connected to the LAN 56 through a network interface 60. The computing device 10 is also connected to WAN 58 and includes a modem 62 for establishing communications over the WAN 58. The modem 62, which may be internal or external, is connected to the system bus 16 via the I/O interface 46. Order 206 is received through either network interface 60 or modem 62.

In a networked environment, program modules depicted relative to the computing device 10, or portions thereof, may be stored in the remote memory storage device 54. For example, application programs may be stored utilizing memory storage device 54. In addition, data associated with an application program may illustratively be stored within memory storage device 54. It will be appreciated that the network connections shown in FIG. 7 are exemplary and other means for establishing a communications link between the computers, such as a wireless interface communications link, may be used.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. A computer-implemented method comprising:
receiving a search phrase from a client device;
identifying a category of products that was previously assigned to the search phrase, wherein the category of products was previously assigned to the search phrase based on products selected by previous users who entered the search phrase;
retrieving search parameters associated with the category;
using the search parameters to control content of a search result page that is formed in response to the received search phrase; and
returning the search result page to the client device.

2. The computer-implemented method of claim 1 wherein the search parameters comprise least one of: search result parameters used to control which facets appear on the search result page, search result parameters used to control which facets appear in an expanded form on the search results page, search result parameters used to control sizes of product images in the search results page and search result parameters are used to control sorting of products in the search results page.

3. The computer-implemented method of claim 1 wherein the category of products is one of a hierarchy of product categories.

4. The computer-implemented method of claim 3 wherein the category of products was previously assigned to the search phrase by finding a lowest level of category in the hierarchy of product categories that a majority of the products selected by previous users belong to.

5. The computer-implemented method of claim 1 wherein the search parameters comprise search rules used to search for products matching the search phrase.

6. The computer-implemented method of claim 5 wherein the search rules comprise at least one of: product fields in an index to be searched, whether to search for variations on the search phrase; weights to apply to product fields, and whether to use a classifier to identify products to return for the search phrase.

7. The computer-implemented method of claim 1 wherein a category of products was previously assigned to the search phrase based on products selected only during a previous week.

8. A server comprising:
a memory storing search parameters for each of a plurality of categories; and
a processor executing instructions to perform steps comprising:
identifying a list of products selected by users after the users entered a search phrase;
identifying a category that products in the list of products belong to;
assigning the category to the search phrase;
receiving the search phrase;
retrieving from the memory the search parameters for the category assigned to the search phrase; and
using the retrieved search parameters to return search results.

9. The server of claim 8 wherein identifying a list of products selected by users after the users entered a search phrase comprises requiring that the list of products only include products selected within a specified limited time interval.

10. The server of claim 8 wherein the search parameters comprises at least one of a facet for filtering search results, a state for a facet, a size for product pictures in the search results, and how to sort products in the search results.

11. The server of claim 8 wherein the search parameters comprises a search rule that affects a search for products using the search phrase.

12. The server of claim 11 wherein the search rule that affects a search for products affects at least one of: what fields to search, how to alter the search phrase before searching, and how to weight fields that are searched.

13. The server of claim 8 wherein assigning a category comprises assigning a category from a hierarchy of categories.

14. The server of claim 13 wherein assigning a category comprises identifying a lowest level category from the hierarchy of categories that a majority of the products in the list of products belong to.

15. A method comprising:
at set intervals:
identifying products selected from search results returned for a search phrase during a latest interval;
identifying a category of products from the identified products;
assigning the category to the search phrase; and
receiving the search phrase in a search request;
retrieving the category assigned to the search phrase;
retrieving search parameters assigned to the category; and
using the search parameters to return search results based on the received search phrase.

16. The method of claim 15 further comprising receiving a second search phrase, determining if phrase-specific search parameters have been set for the second search phrase and using the phrase-specific search parameters instead of the search parameters assigned to a category assigned to the second search phrase to return search results based on the received second search phrase.

17. The method of claim 15 further comprising receiving a third search phrase, determining that no category has been assigned to the third search phrase and in response using default search parameters to return search results based on the third search phrase.

18. The method of claim 16 wherein the search parameters comprises parameters that define at least one of what filter facets are displayed in the search results, which filter facets are shown in an expanded form, the size of product images displayed in the search results and the order of products displayed in the search results.

19. The method of claim 16 wherein the search parameters comprise search parameters that control how products are searched for using the search phrase.

20. The method of claim 19 wherein the search parameters comprise at least one of what fields to search, how to weight different fields that are searched, and how to modify the search phrase before searching.
